(19) United States
(12) Patent Application Publication
(10) Pub. No.: US 2006/0275101 A1
(43) Pub. Date: Dec. 7, 2006

(54) Eyeglass assembly and fastening arrangement for assembly thereof

(76) Inventors: Zvi Feldman, ZORAN (IL); Eyal Peleg, Zoran (IL)

Correspondence Address: MORGAN LEWIS & BOCKIUS LLP, 1111 PENNSYLVANIA AVENUE NW, WASHINGTON, DC, 20004, US

(21) Appl. No.: 10/538,009

(22) PCT Filed: Dec. 4, 2003
(86) PCT No.: PCT/IL03/01029

§ 371 Date: Jun. 3, 2005

Related U.S. Application Data
(60) Provisional application No. 60/430,943, filed on Dec. 5, 2002.

(51) Int. Cl. F16B 15/06

(52) U.S. Cl. 411/456

(57) ABSTRACT

A fastening arrangement for use with a curved lens having a first face, a second face and a bore passing between them and having a longitudinal axis slanted to the lens's faces, for attaching to the lens a component at the first face of the lens. The fastening arrangement comprises a fastener having a lens-face engaging portion adapted to engage the second face of the lens and a component engaging portion entering the bore at the second face, and further comprises a fastener engaging portion in the component adapted to engage the component engaging portion of the fastener. All the engaging portions are designed so that when the component and curved lens are assembled, the lens-face engaging portion is oriented along the second face. The invention further relates an eyeglass assembly comprising such a fastening arrangement and associated components and fasteners.

### FIELD OF THE INVENTION

This invention relates to a fastening arrangement for assembling a component to a lens.

### BACKGROUND OF THE INVENTION

In the assembly of eyeglasses and eyeglass accessories (such as auxiliary lenses) it is necessary to join components to the lenses thereof. These components can be, for example, clips that attach to auxiliary lenses such as radiation filtering lenses, or the components can be temple-arms or nose-pieces for attaching to eyeglass lenses such as those of prescription eyeglasses or sun-glasses.

U.S. Pat. No. 5,889,574 discloses a typical eyeglass clip-on accessory consisting of a pair of rimless non-optical lenses joined together by a bridge, the lenses having clips fastened thereon to engage the frame of eyeglasses. The clips are attached to the lenses by screws.

U.S. Pat. No. 6,234,628 describes a pair of clip-on sunglasses whose lenses are in a frame having L-shaped plastic prongs to couple the clip-on onto the frame of spectacles.

U.S. Pat. No. 5,724,118 describes a clip-on having lenses mounted in rings to which hooks are cemented or welded for connecting the clip onto the frame of spectacles.

U.S. Pat. No. 6,089,706 describes a clip-on whose lenses are held in a wire frame. A wire passes through hooks to attach the clip-on to the frame of eyeglasses.

U.S. Pat. No. 6,254,232 describes spring-biased clamping arms which act to clamp a clip onto the frame of eyeglasses.

U.S. Pat. No. 6,116,731 describes a connection between sunglasses and optical eyeglasses by means of plug-in projections. U.S. Pat. No. 6,196,679 discloses a similar connection.

U.S. Pat. No. 5,694,192 discloses a clip-on whose coupling clips are joined to lenses by a tension thread.

U.S. Pat. No. 6,244,704 describes such a clip to filter-lens attachment using welding.

### SUMMARY OF THE INVENTION

The present invention generally relates to an eyeglass assembly and a fastening arrangement for assembly thereof. The fastening arrangement is used for assembling a component, e.g. a clip, to a lens such as described, for example, in Applicant's U.S. Pat. No. 6,607,270.

The term lens or lenses as used herein refers to any lens including auxiliary lenses (such as those of an eyeglass clip accessory, e.g. a sunglass clip-on, or lenses having optical properties so that when it is placed in front of an optical lens they combine therewith to form a compound lens for visual correction) as well as prescription eyeglass lenses and non-prescription eyeglass lenses (such as safety lenses and sunglass lenses, etc.).

The invention is particularly useful for fastening a clip component of a clip-on accessory to an auxiliary lens such as a sunglass lens which is commonly clipped to a pair of prescription eyeglasses. Therefore, the invention will be primarily described in this context although the component could be any other member, e.g. a temple arm or nose piece to be attached to an optical lens of frameless eyeglasses or sunglasses.

According to one aspect of the present invention, there is provided a fastening arrangement for use with a curved lens having a first face, a second face and a bore passing between them and having a longitudinal axis slanted to the lens's faces, for attaching to the lens a component at the first face of the lens; the fastening arrangement comprising a fastener having a lens-face engaging portion adapted to engage the second face of the lens and a component engaging portion entering the bore at the second face, and further comprising a fastener engaging portion in the component adapted to engage the component engaging portion of the fastener; all the engaging portions being designed so that when the component and curved lens are assembled, the lens-face engaging portion is oriented along the second face; and an eyeglass assembly comprising such a fastening arrangement.

According to one embodiment of the present invention, the component engaging portion of the fastener and the fastener engaging portion of the component are not threaded, with the lens-face engaging portion being is slanted relative to its component engaging portion. In this case, the fastener may be a pin having a head and a stem, with the head having a slanted bottom surface. Alternatively, the fastener may have a wedge-shaped portion, integrally or non-integrally to the head.

According to another embodiment of the present invention, the lens-face engaging portion of the fastener is not slanted relative to its component engaging portion, rather the fastener engaging portion of the component is slanted with respect to the axis of the bore so that its axis is perpendicular to the corresponding face of the lens. In this case, the fastener may be either threaded or not threaded.

According to yet another embodiment of the present invention the fastening arrangement comprises a diskette or ring whose bottom surface constitutes the lens-face engaging portion of the fastener. The ring is adapted to align the fastener with the bore and to interface with the lens-face with its lens-face engaging portion. This ring may be integrally formed with the component or a separate piece.

According to a further embodiment of the previous invention, the fastening arrangement wherein the component comprises a lens interfacing surface with a spherically shaped portion which interfaces with the bore to ensure fill contact therebetween, when the fastener engaging portion of the component engages the component engaging portion of the fastener.

The arrangement of the present invention in which the lens-face engaging portion of the fastener is aligned with the lens's corresponding face has a plurality of advantages including the following:
Stress applied to the lens during assembly is minimized.
Different components are easily attached to the lenses.
The components can interface with the lens's face to which they are attached even if this face is curved.
The chance for the assembly loosening or coming apart is reduced.
The clips and lenses can be mass-produced at relatively low cost.

According to another aspect of the present invention, there is provided a fastening arrangement comprising a fastening arrangement for assembly of a component to a lens, the lens having an edge and the component being L-shaped and having a ledge formed with a fastener engaging portion and a leg having a lens-edge interfacing portion, wherein the edge of the lens and the lens-edge interfacing portion of the component have inter-engaging parts to minimize movement between the lens and the component.

Typically, the inter-engaging parts are outside the edge of the lens and so both the field of vision of the wearer and the aesthetic virtues of the clip-on and lens are not be affected by the presence of the clips and inter-engaging parts.

According to another aspect of the present invention, there is provided a fastening member for use in attaching a component to a lens, the lens having a through bore and the component comprising a fastener engaging portion and being adapted for the attachment to the lens at the bore via a fastener having a component engaging portion, the component further comprising a spherically shaped portion which interfaces with the bore to ensure full contact therebetween, when the fastener engaging portion of the component engages the component engaging portion of the fastener.

When a threaded fastener is used in such a fastening arrangement, it is very important that it is tightened to an extent for reliably holding the assembly together while avoiding excessive stress on the lens material and the clip.

Therefore, according to a further aspect of the present invention, the fastening arrangement for assembly of a component to a lens comprises a bore passing therethrough; the fastening arrangement comprising a threaded fastener entering the bore and a fastener engaging portion, wherein the fastener comprises an arm connected therewith via a neck and designed to disconnect therefrom at the neck at a predetermined fastening torque upon the inter-engagement between the fastener and the fastener engaging portion.

By one embodiment of the present invention, this arrangement may further comprise a tool adapted for engaging the arm for ease of and reliability of assembly with use of the appropriate fastening torque.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is an illustration of a prior art arrangement for attaching a component to a lens;

FIG. 2A is a cross-sectional view of a fastening arrangement for attaching a component to a lens according to an embodiment of the present invention, in which the arrangement comprises a fastener with a slanted lens-face engaging portion;

FIG. 2B is a cross-sectional view of a modification of the fastening arrangement of the embodiment of FIG. 2A;

FIG. 2C is a cross-sectional view of another modification of the fastening arrangement of the embodiment of FIG. 2A;

FIG. 3 is a cross-sectional view of a fastening arrangement according to another embodiment of the present invention, in which the component has a slanted fastener engaging portion;

FIG. 4A is a cross-sectional view of a fastening arrangement according to yet another embodiment of the present invention, in which the arrangement comprises a lens-face engaging portion in the form of a ring;

FIG. 4B is a top view of the ring of FIG. 4A.

FIG. 4C is a cross-sectional view of a modification of the embodiment of FIG. 4A, in which the ring is integrally formed with the component;

FIG. 5 is a cross-sectional view of a fastening arrangement according to still another embodiment of the present invention, in which the component comprises a spherical portion interfacing the lens;

FIG. 6 is a cross-sectional view of a fastening arrangement according to a further embodiment of the present invention;

FIG. 7A is a cross-sectional view of a fastening arrangement according to yet another embodiment of the present invention, in which the lens and the component further comprise inter-engaging portions to prevent rotation therebetween;

FIG. 7B is a view of FIG. 7A along the line A-A;

FIG. 7C illustrates a modification of the embodiment of FIG. 7A; and

FIGS. 8A and 8B illustrate a still further embodiment of the fastening arrangement of the present invention, wherein the fastener incorporates an arm for facilitating and controlling the fastening, and the arm has associated therewith a tool for engaging the arm.

### DETAILED DESCRIPTION OF THE INVENTION

Applicants' U.S. Pat. No. 6,607,270, incorporated herein by reference, describes clip-ons where fastening arrangements in accordance with all embodiments of the present invention may be advantageously used. Therefore, clip-ons will not be described herein in any detail, rather the emphasis will be on the description of embodiments of fastening arrangements of a component, particularly a clip, to a lens. As mentioned above, the same arrangements may be suitable for lenses other than auxiliary lenses and for components other than clips.

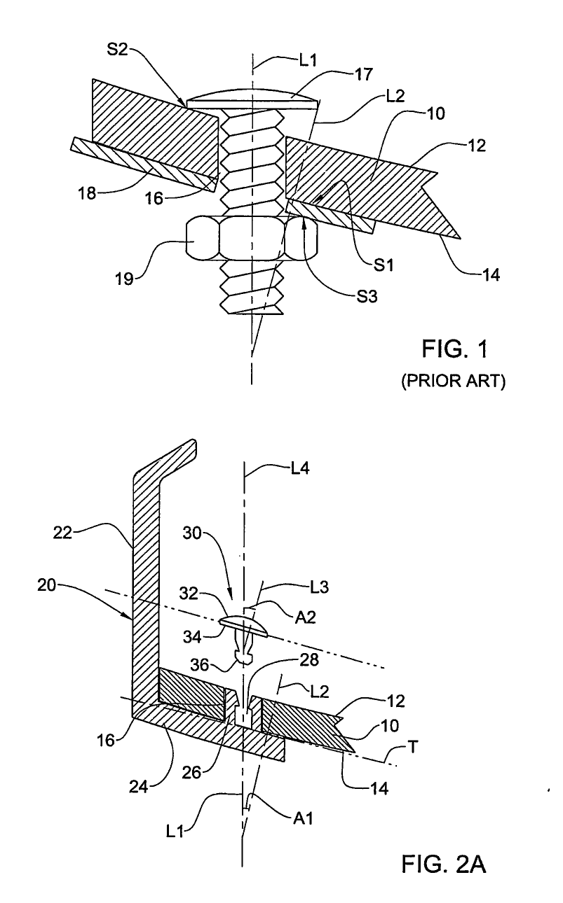

Referring now to FIG. 1, a prior art fastening arrangement is shown illustrating one of the problems with such arrangements. In FIG. 1, a lens 10 is shown having an inner face 12, an outer face 14, an edge 15 and a bore 16 formed therein, typically slightly inward of the edge of the lens. The faces 12 and 14 are curved. A component 18 is attached to outer face 14 of the lens by a screw 17 inserted in the bore 16 and a nut 19 carried by the screw. The bore 16 has a longitudinal axis L1 defining its orientation relative to the lens's faces. The bore 16 may be formed so that its axis L1 is slanted relative to an axis L2 normal to the lens's inner face 12 at the location of the bore, or it may be normal to the inner surface 12 of the lens, the former design being more common for lenses with curved faces, due to the conventional methods of lens production, as detailed herein-below.

The drilling of bores in lenses is typically performed by one of two methods, namely the so-called “radial” method or “parallel” method.

The “radial” method is less common and involves drilling holes (bores) in the lens in a direction that would pass through a virtual point located at the center of a circle defined by the curvature of the lens; thus the drilling extends radially from such a center point. In other words, the drilling is normal to the face of the lens, i.e. normal to a plane tangent to the face at the location of drilling. This method may involve complications connected with holding the lens in the right orientation as this might change from one hole to another depending on the shape of the lens and on the location of the hole with respect to the center of the virtual point.

A more common and convenient practice is referred to as “parallel drilling”, where the lens is held in a so-called “horizontal position” and the drill bit is introduced to the lens vertically. The “parallel method” is the common practice of drilling holes or bores in lenses due to the low cost and simplicity. When bores are drilled in lenses using the “parallel method”, the resultant bores are parallel to each other and not perpendicular to the face of the curved lens.

Reverting to FIG. 1, when the lens 10 and the component 18 are assembled by means of the screw 17 and nut 19 at the slanted bore 16, an excessive force is applied at a point S1 on the inner face 12 and a point S2 on the outer face 14 of the lens 10; as well as at a point S3 on the component. Since this force is applied on a significantly small area, the stresses caused by the applied force can be extremely high. When a rigid material, such as glass or thermoplastic polymer, is exposed to high stress, it may develop internal stresses resulting in crazing or cracking. This phenomenon is usually referred to as “stress concentration” and it is well known among those of the art.

Furthermore, the above fastening arrangement may also result in the premature loosening of the screw 17 and nut 19 and thus poor contact or even the disconnection of the screw and nut coupling.

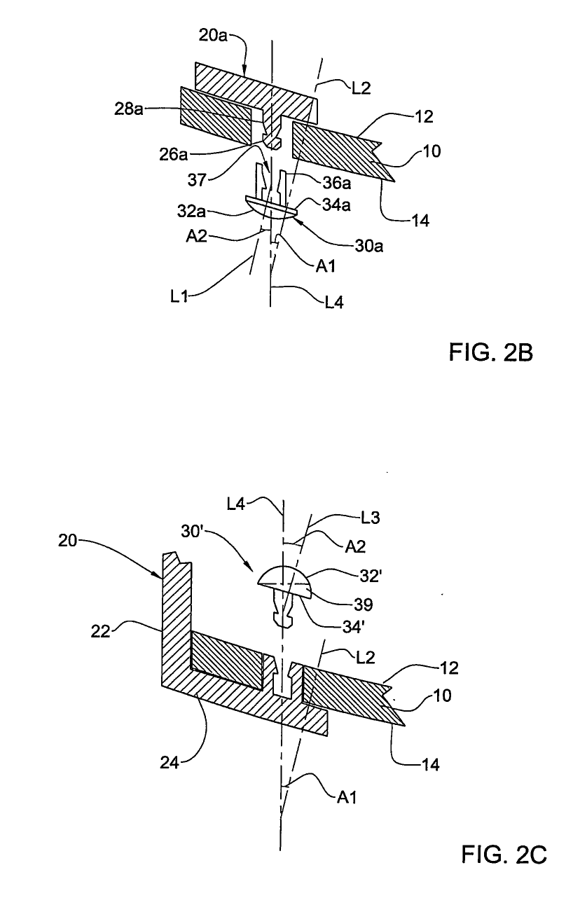

FIG. 2A shows a first embodiment of an eyeglass assembly and fastening arrangement for assembly thereof designed to minimize the stress concentration that may occur upon fastening a component, such as a clip, to a curved lens. The curved tens 10 comprises the slanted bore 16, common in the production of such lenses as discussed above; the bore having the longitudinal axis L1. A component in the form of a clip 20 is shown aligned for fastening to the face 14 of the lens 10, the clip having an L-shape with a leg 22 and a ledge 24. The ledge 24 is formed with a slanted plug 26, corresponding to the slanted bore 16. The plug 26 has a cavity 28 constituting the clip's fastener engaging portion coaxial with the bore 16. The slant of the bore 16 and the cavity 28 is defined by an angle A1 between their longitudinal axis L1 and an axis L2 normal to the faces 12 and 14 of the lens 10. It should be understood that since faces 12 and 14 are curved, axis L2 is normal to these faces only in the area of the bore 16.

The ledge 24 typically has a slight curve to correspond with the curve of the lens 10, as made clearer by dashed line T which is tangent to the lens at the point where the lens has been bored.

Further seen in FIG. 2A is a fastener in the form of a pin 30 having a head 32 with a bottom surface 34 constituting a lens-face engaging portion, and a component engaging portion in the form of a stem 36. The head 32 has an axis L3 which is normal to its bottom surface 34 and parallel to the lens faces' normal axis L2. The stem 36 has a longitudinal axis L4 parallel to the axis L1 of the cavity 28. To compensate for the slant expressed by angle A1, the head 32 is slanted with respect to the stem 36 at an angle A2 equal to the angle A1. Thus, when the pin 30 correspondingly engages the cavity 28 its head 32 interfaces with the inner face 12 and is oriented along this face. This engagement reduces the possibility of high stress to the lens 10 since the planar bottom surface 34 of the head 32 is now essentially parallel to the lens' inner face 12.

The head 32 of the pin 30 may have any shape although a configuration such as hex-shape may be advantageous for gripping. The plug 26 and the stem 36 are typically co-designed such that the stem snappingly engages with the cavity 28 in a male-female relationship.

It is noticed that the plug 26 is integrally formed with the clip's ledge 24 which eliminates the need for a nut (such as the nut 19 of prior art FIG. 1).

FIG. 2B illustrates a modification of the embodiment of FIG. 2A wherein the male/female fastening relationship is switched. Thus, in this modification there is a component in the form of a clip 20a comprising a ledge 24a having a male plug 26a with a cavity 28a corresponding to a fastener in the form of a female pin 30a having a head 32a with a lens-face engaging portion in the form of a bottom surface 34a and whose component engaging portion is in the form of a stem 36a, typically cylindrical and having a suitably shaped hollow portion 37. Other components and principles of the fastening arrangement are analogous to those of FIG. 2A.

It should be understood that instead of the entire head of the pin being slanted, there could be a pin 30′ with an alternately shaped head 32′ comprising a wedge-shaped portion 39 to thereby orient its bottom surface 34′ along the lens' inner face 12; as shown in FIG. 2C.

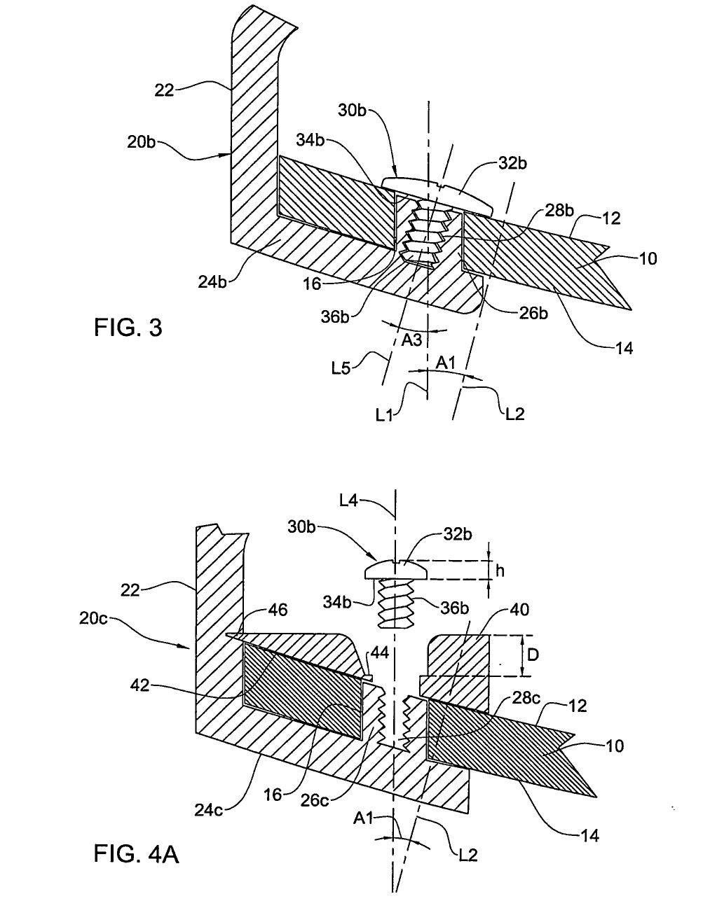

FIG. 3 illustrates another embodiment of the present invention for fastening a clip to a lens involving minimal stress concentration in the lens, in which a fastener with a standard configuration may be used. In this embodiment, fasteners in the form of a screw, bolt, rivet, etc, as well as a pin are suitable.

The differences between the embodiments of FIG. 2A and FIG. 3 are mainly in that there is a component in the form a clip 20b, with a plug 26b whose cavity 28b has a longitudinal axis L5 slanted with respect to the axis L1 of the plug and the bore 16 so as to be parallel to the axis L2, and the cavity 28b is adapted for receiving a fastener that is in the form of a screw 30b (although a pin, bolt, rivet or the like could also be used, mutatis mutandis). The slant of the cavity's longitudinal axis L5 with respect to the longitudinal axis L1 of the plug 26b and the bore 16 (angle A3) compensates for the slant (angle A1) between the axis L1 and the axis L2 which is normal to the inner face 12.

Thus, the screw 30b, which has a stem 36b constituting the component engaging portion and a head 32b with a lens-face engaging portion in the form of a bottom surface 34b, interfaces with the lens 10 such that the bottom surface is oriented along the inner face 12 thereof.

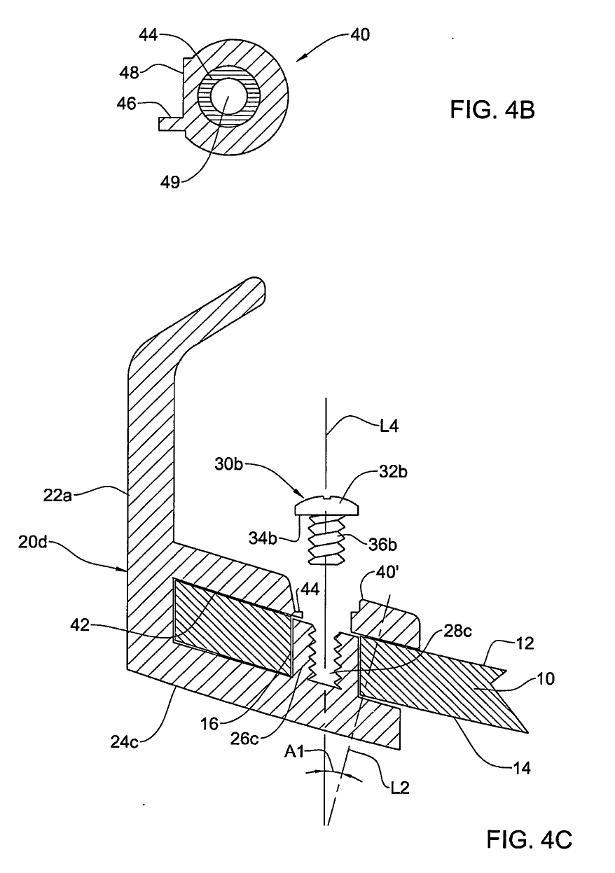

FIGS. 4A to 4C illustrate other embodiments of the eyeglass assembly and fastening arrangement therefor having a related nature. FIG. 4A relates a fastening arrangement wherein the fastener comprises a lens-face engaging member in the form of a diskette or ring 40. The ring 40 is shown having a wedge-shaped profile which facilitates assembling a component in the form a clip 20c to the lens 10 with minimal stress applied thereto.

The ring 40 has a lower surface 42 which is shaped to smoothly interface the lens's inner face 12. The ring 40 also has an annular shoulder 44 which corresponds to the screw head's bottom surface 34b and interfaces therewith upon fastening. The shoulder 44 is typically recessed to a depth D being larger than the height h of the screw head 32b to prevent the screw 30b from catching on material or on a wearer or assembly-person; as well as for aesthetic reasons.

In this arrangement, the clip 20c comprises a ledge 24c with a plug 26c having a cavity 28c that is co-axial to the plug and constitutes a fastener engaging portion of the clip 20c. The fastener can be a standard screw though, as previously mentioned, a variety of fastener types could be used.

With the incorporation of the ring 40, the fastening arrangement is such that the screw head 32b has an axis L4 coinciding with that of the stem 36b and the cavity 28c. Further, even though both the screw head 32b and the stem 36b are slanted with respect to axis L2 (normal to the lens faces 12, 14), there is an essentially even force applied to the lens 10 during fastening—thus, the stress applied thereto is minimized. Moreover, as the ring 40 has a larger surface area at its lower surface 42 than the screw head's bottom surface 34b, the pressure on the lens 10 is further reduced.

The ring 40 may also comprise a projection 46 designed to interface with the leg 22 of the clip 20c to facilitate proper alignment and to prevent rotation thereof during fastening. The projection 46 typically interfaces an outside surface of the leg 22 and would therefore not be visible in a cross-sectional view, however, for explanatory purposes it is shown as if it is in the plane of the cross-section. The form and typical position of this projection 46 is better seen in FIG. 4B which shows a top view of the ring 40 further illustrating its geometry including a through-bore 49. Adjacent the projection 46 is a generally flat portion 48, which may rest up against a corresponding portion of the leg 22 of the clip 20c. This interface also helps properly position the ring 40 and limits rotation thereof. The ring 40 can be shaped to facilitate inserting the screw 30b and is therefore illustrated as having a somewhat funnel-shaped recess above its shoulder 44; and the ring can help align the screw.

FIG. 4C shows a modification to the embodiment of FIG. 4A wherein there is a component in the form a clip 20d comprising a leg 22a with a ring 40′ integrally attached thereto. The ring 40′ provides the same function as the ring 40 of FIG. 4A although there is no projection 46. It is noteworthy that the ring 40′ is not wedge-shaped. Regardless, its lower surface 42 still corresponds to the inner face 12, with the shoulder 44 properly positioning the fastener.

Since the ring 40′ is integral with the clip's leg 22a, it cannot move (slide or rotate) relative thereto and is mated properly with the lens's inner surface 12 and its through-bore 49 is aligned appropriately with the bore 16 as a result of proper manufacturing.

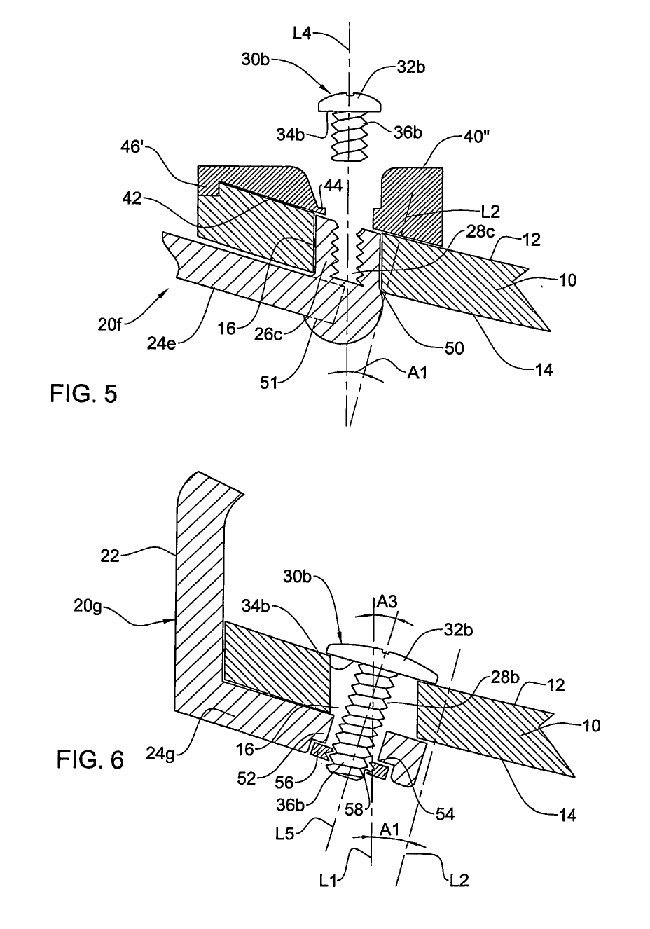

FIG. 5 illustrates yet another embodiment for a clip-to-lens fastening arrangement wherein there is a component in the form a clip 20f with a ledge 24e having a plug 26e that comprises a spherically shaped portion 50. The spherically shaped portion 50 interfaces with the bore 16 at the lens's outer face 14. Dashed lines 51 illustrate that the component 20f and the spherically shaped portion 50 may be non-integral parts, although they may also be integrally formed. Furthermore, spherically shaped portion 50 may be in the form of only a partial sphere (e.g. hemi-sphere) with the stipulation that a spherical portion thereof interface with the bore 16.

It is also noticed that the lens-engaging portion may be a ring 40′ which has an L-shaped projection 46′ designed to interface with the lens 10.

Thus, even though the edge of the bore 16 is slightly elliptical due to the curvature of the lens 10, as a result of the geometry of the spherically shaped portion 50 there is an even contact at the bore.

FIG. 6 illustrates a further embodiment wherein the fastening arrangement comprises a component in the form of a clip 20g having a ledge 24g comprising a fastener alignment portion 52 oriented parallely to the lens's inner face 12 and thus normal to axis L2. The portion 52 may have an integral fastener engaging portion such and therefor be threaded to suit a corresponding fastener.

Alternatively, or in addition, the fastener alignment portion 52 can comprise a surface 54 and be adapted to receive a fastener engaging portion in the form of a nut 56. The nut 56 interfaces the surface 54 so as to be aligned with the fastener, screw 30b, and to orient the nut 56, so that the bottom surface 34b of the screw if oriented along the lens's inner face 12. This fastener alignment portion 52 can be constituted by the outer edge of the ledge 24g or have a recessed portion whereby the nut 56 does not protrude from the ledge. It is noticed that the fattener engaging portion is now in the form of a threaded portion 58 of the nut 56.

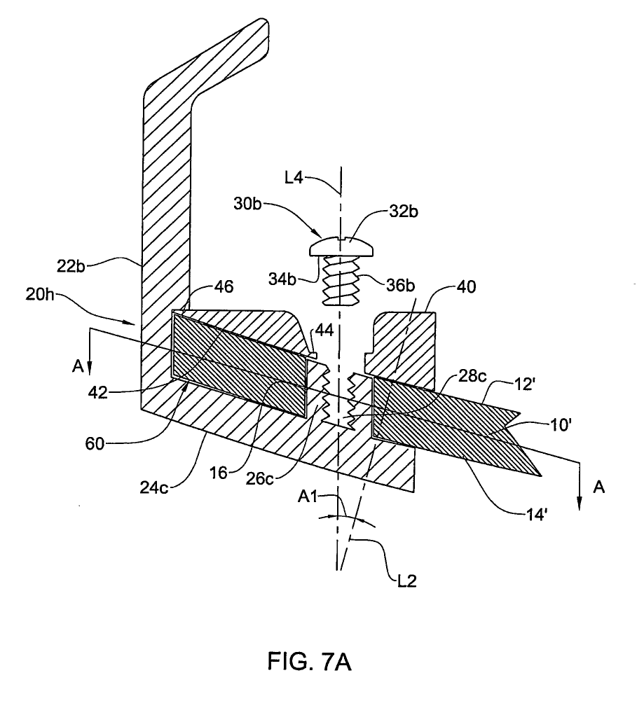

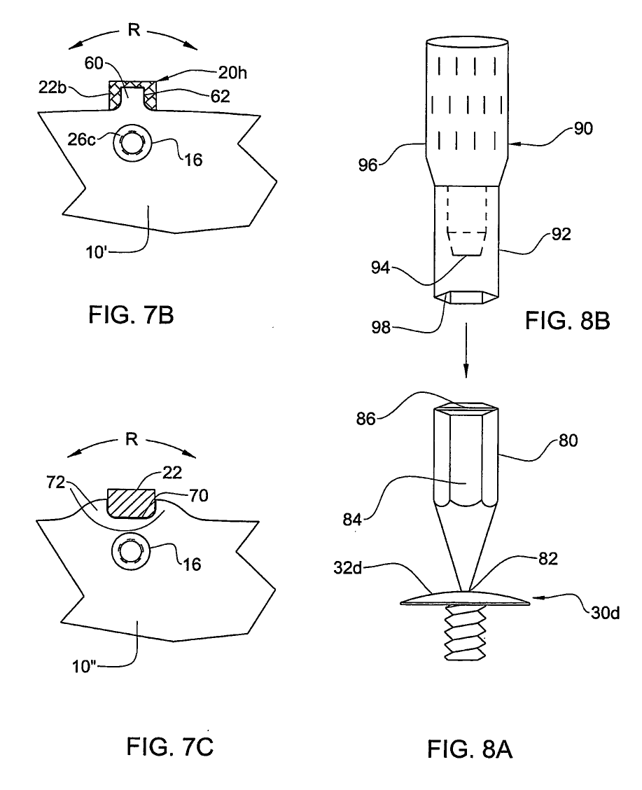

FIGS. 7A to 7C illustrate additional embodiments of the present invention in which an eyeglass assembly and fastening arrangement are designed to further stabilize the assembly against movement, especially against rotation between a clip and a lens. These embodiments can be used with any conventional fastening arrangement, not only those described herein.

FIGS. 7A and 7B show one of these embodiments wherein a component in the form of a clip 20h and a lens 10′ comprise inter-engaging parts. For illustrative purposes only, this embodiment is shown in combination with the embodiment of FIG. 4A, however all the embodiments shown in FIGS. 7A to 7C can be used in combination with any of the herein described embodiments.

The clip 20h has a leg 22b with an indentation 62 and the lens 10′ comprises a projection 60, typically an integral part thereof, designed to inter-engage with the clip's indentation to prevent rotation between the clip and the lens about the bore's axis L1.

FIG. 7B provides a section of FIG. 7A along the line A-A for better visualization of the inter-engagement.

One reason contributing to the potential rotation, indicated by arrow R, is that the fastening is at one point in the lens 10—namely at the bore 16. Another reason is due to the elastic properties of the materials from which clips and/or lenses are made and this may cause loosening of the assembly.

Another embodiment designed to prevent this rotation is shown in FIG. 7C and uses a similar concept. However, here a lens 10″ comprises a recess 70 which the leg 22 fits therein. The recess 70 is formed and defined by bulges 72 in the contour of the edge of the lens 10″. Thus, due to inter-engaging parts of the lens 10″ and the clip 20g, rotation is again prevented, and, since the bulges 72 are external to the normal area of lenses, the clip's leg 22 does not infringe on the field of view.

Lens configurations as described above can be produced by a machine using a production process which obtains the lens's contour in a digital form as disclosed in applicant's U.S. Pat. No. 6,607,270. Contours of a lens and their digital presentation can be modified to include the above described configurations and/or other modifications may also be made in the contours, for example, in order to achieve a desired aesthetic effect. The final contours may then be input to a milling machine for shaping the lenses from blanks.

Still an additional embodiment of the present invention will now be described with reference to FIG. 8A in which the fastening arrangement comprises a fastener in the form of a screw 30d having a head 32d with an arm 80 attached thereto.

The arm 80 is used for applying and controlling the torque applied to the screw 30d and is connected thereto by a neck 82 typically at the center of the screw's head 32d. The neck 82 is designed to fail at a predetermined torque at which point the arm 80 detaches from the screw 30d and thus the predetermined torque is applied.

The arm 80 preferably comprises longitudinal flat sections 84 and/or a slot 86 for engagement with a tool (FIG. 8B) for applying torque such as a wrench or a screw driver, respectively. Such a tool 90, adapted for engagement with the arm 80, is also shown and comprises a sleeve 92, an engaging portion 94 and a grip 96.

The sleeve 92 fits over the arm 80 to hold it and thereby hold the screw 30d and so that when the arm detaches from the screw head 32d it is held therein. The sleeve may further help prevent the tool 90 from slipping there-from upon torquing. The engaging portion 94 is designed to engage with the slot 86. Alternatively, or in addition to, the sleeve 92 may have and inner surface 98 adapted to correspond to the flat portions 84 of the arm 80. Further, for ease of use, the sleeve 92 may flare out for easy engagement and positioning on the arm 80.

While the just-described tool-arm arrangement is applicable to a variety of fasteners and fastening applications, especially for which a predetermined torque is desired, it is particularly useful for the above-describe application since the arm 80 facilitates handle-ability and assembly of small components and essentially precludes accidental damaging (e.g. scratching) lenses.

Further, this arrangement enables fast, exact and reliable fastening of fasteners without the use of particularly skilled labor, and the fastener cannot be accidentally tightened more than the predetermined torque, regardless of the force applied thereto by the assembly-person.

It will be appreciated by persons skilled in the art that the present invention is not limited by what has been particularly shown by the exemplary embodiments described hereinabove. Thus, the fastener assembly and fastening arrangement therefor can be embodied by a variety of aspects within the scope of the invention, mutatis mutandis.

1. A fastening arrangement for use with a curved lens having a first face, a second face and a bore passing between them and having a longitudinal axis slanted to the lens's faces, for attaching to said lens a component at the first face of the lens; the fastening arrangement comprising a fastener having a lens-face engaging portion adapted to engage the second face of the lens and a component engaging portion entering the bore at said second face; said fastening arrangement further comprising a fastener engaging portion in said component adapted to engage said component engaging portion of the fastener; all the engaging portions being designed so that, when the component and the lens are assembled, the lens-face engaging portion is oriented along said second face of the lens.

2. The fastening arrangement according to claim 1, wherein said fastener has a head and a stem with a longitudinal axis, said stem constituting said component engaging portion.

3. The fastening arrangement according to claim 2, wherein said head has a bottom surface constituting said lens-face engaging portion.

4. The fastening arrangement according to claim 3, wherein said stem of the fastener is coaxial with said bore in the lens and said bottom surface of the fastener's head is slanted with respect to said longitudinal axis of the stem so as to be oriented along said second face of the lens, when the lens and the component are assembled.

5. The fastening arrangement according to claim 2, wherein said fastener comprises a lens-face engaging member having a lower surface that constitutes a lens-face engaging surface and a top surface adapted to engage said head, said member having a through bore coaxial with said bore of the lens.

6. The fastening arrangement according to claim 5, wherein said lower surface is slanted with respect to said longitudinal axis of the stem so as to be oriented along said second face of the lens when the lens and the component are assembled.

7. The fastening arrangement according to claim 5, wherein the lens-face engaging member comprises means to facilitate fixing its position relative to the lens.

8. The fastening arrangement according to claim 7, wherein said means is in the form of a projection and said component is L-shaped and has a ledge formed with said fastener engaging portion and a leg to support the lens's edge, said means interfacing said leg.

9. The fastening arrangement according to claim 7, wherein said means is in the form of a projection interfacing with the lens.

10. The fastening arrangement according to claim 5, wherein said lens-face engaging member has a recess in its top surface formed around said through bore and a shoulder in said recess surrounding said bore, with which said head of the fastener interfaces.

11. The fastening arrangement according to claim 10, wherein the shoulder is designed such that the longitudinal axis of the stem is parallel to that of the bore.

12. The fastening arrangement according to claim 10, wherein said recess has a depth greater than the height of the fastener's head.

13. The fastening arrangement according to claim 1, wherein the component engaging portion has a longitudinal axis normal to said second face of the lens.

14. The fastening arrangement according to claim 1, wherein the component engaging portion has a longitudinal axis parallel to the longitudinal axis of the bore.

15. The fastening arrangement according to claim 1, wherein said component is formed with a plug received within said bore, said plug being formed with a cavity constituting said fastener engaging portion having a longitudinal axis.

16. The fastening arrangement according to claim 15, wherein said longitudinal axis is slanted with respect to the second lens face.

17. The fastening arrangement according to claim 1, wherein the component engaging portion of the fastener connects to the fastener engaging portion of the component in a male-to-female configuration, respectively.

18. The fastening arrangement according to claim 1, wherein the component engaging portion of the fastener connects to the fastener engaging portion of the component in a female-to-male configuration, respectively.

19. The fastening arrangement according to claim 1, wherein the component comprises a lens interfacing surface with spherically shaped portion which interfaces with the bore to ensure full contact therebetween, when the fastener engaging portion of the component engages the component engaging portion of the fastener.

20. The fastening arrangement according to claim 19, wherein said spherically shaped portion is a non-integral part of said component.

21. The fastening arrangement according to claim 1, wherein the component has a ledge which is curved and corresponds with the first face of the lens.

22. The fastening arrangement according to claim 1, wherein the lens has an edge and the component is L-shaped and has a ledge formed with said fastener engaging portion and a leg having a lens-edge interfacing portion.

23. The fastening arrangement according to claim 22, wherein said edge of the lens and said lens-edge interfacing portion of the component have inter-engaging parts to minimize movement between the lens and the component.

24. The fastening arrangement according to claim 23, wherein said inter-engaging parts has a male-female design.

25. The fastening arrangement according to claim 24, wherein said inter-engaging parts are in the form of a projection formed at the edge of the lens and a corresponding indentation formed in said lens-edge interfacing portion of the component.

26. The fastening arrangement according to claim 24, wherein said parts are in the form of a projection formed at said lens-edge interfacing portion of the component and a recess formed in the edge of the lens, said recess being disposed between bulges protruding from said edge.

27. The fastening arrangement according to claim 1, wherein said component engaging portion of the fastener and the fastener engaging portion of the component are inter-engageable in a threaded fashion.

28. The fastening arrangement according to claim 27, wherein the fastener is formed with an arm connected therewith via a neck and designed to disconnect therefrom at said neck at a predetermined fastening torque upon the inter-engagement between the fastener engaging portion and the component engaging portion.

29. The fastening arrangement according to claim 28, wherein the fastening arrangement further comprises a tool adapted to hold the arm.

30. The fastening arrangement according to claim 29, wherein the tool comprises a sleeve designed to fit over at least a portion of the arm.

31. The fastening arrangement according to claim 1, wherein the component is a clip of an eyeglass clip-on.

32. A fastening member for use in attaching a component to a lens, the lens having a through bore and the component comprising a fastener engaging portion and being adapted for the attachment to the lens at the bore via a fastener having a component engaging portion, the component further comprising a spherically shaped portion which interfaces with the bore to ensure full contact therebetween, when the fastener engaging portion of the component engages the component engaging portion of the fastener.

33. The fastening member according to claim 32, wherein said spherically shaped portion is a non-integral part of said component.

34. An eyeglass assembly comprising a component, a lens and a fastening arrangement as described in claim 1.

35. A fastening arrangement for assembly of a component to a lens, the lens having an edge and the component being L-shaped and having a ledge formed with a fastener engaging portion and a leg having a lens-edge interfacing portion, wherein said edge of the lens and said lens-edge interfacing portion of the component have inter-engaging parts to minimize movement between the lens and the component.

36. The fastening arrangement according to claim 35, further comprising means for attaching said component to said lens at a location spaced from the lens's edge.

37. The fastening arrangement according to claim 35, wherein said inter-engaging parts are adjacent said location.

38. The fastening arrangement according to claim 35, wherein said inter-engaging parts have a male-female design.

39. The fastening arrangement according to claim 35, wherein said inter-engaging parts are in the form of a projection formed at the edge of the lens and a corresponding indentation formed in said lens-edge interfacing portion of the component.

40. The fastening arrangement according to claim 35, wherein said inter-engaging parts are in the form of a projection formed at said lens-edge interfacing portion of the component and a recess formed in the edge of the lens, said recess being disposed between bulges protruding from said edge.

41. An eyeglass assembly comprising a component and lens as described in claim 35.

42. A fastening arrangement for assembly of a component to a lens comprising a bore passing therethrough; the fastening arrangement comprising a threaded fastener for entering said bore and a fastener engaging portion, the fastener comprising an arm connected therewith via a neck and designed to disconnect therefrom at said neck at a predetermined fastening torque upon the inter-engagement between the fastener and the fastener engaging portion.

43. The fastening arrangement according to claim 42, wherein the fastening arrangement further comprises a tool adapted to hold the arm.

44. The fastening arrangement according to claim 43, wherein the tool comprises a sleeve designed to fit over at least a portion of the arm.

45. A component designed for attaching to a curved lens having a first face, a second face and a bore passing between them and having a longitudinal axis slanted to the lens's faces; the component comprising a fastener engaging portion designed for inter-engaging with a fastener entering the bore at said first face, the fastener engagement portion being designed for entering the bore at said second face and having a longitudinal axis normal to the first face so that, when the component and the lens are attached, the fastener has an interface oriented along the first face of the lens.

46. A component designed for attaching to a curved lens having a first face, a second face and a bore passing between them and having a longitudinal axis slanted to the lens's faces; the component comprising a fastener engaging portion designed for inter-engaging with a fastener entering the bore at said first face and aligning the fastener with the bore; the component further comprising a first and second lens-face engaging portions engageable respectively with said fast and second faces so that, when the component and the lens are attached, the lens-face engaging portions are oriented along the first and second faces of the lens.

47. A non-threaded fastener designed for use in attaching a component to a curved lens having a first face, a second face and a bore passing between them and having a longitudinal axis slanted to the lens's faces; the fastener comprising a lens-engaging portion and a component engaging portion, the lens engaging portion being slanted with respect to the component engaging portion's axis so that, when the lens-face engaging portion of the fastener is oriented along the first and second faces of the lens.

48. A threaded fastener designed for use in attaching a component to a curved lens having a first face, a second face and a bore passing between them and having a longitudinal axis slanted to the lens's faces; the component comprising a fastener engagement portion; the fastener comprising a head with an arm connected therewith via a neck and designed to disconnect therefrom at said neck at a predetermined fastening torque upon the inter-engagement between the fastener and the fastener engaging portion.

49. A component designed for attaching to a curved lens having a first face, a second face and a bore passing between them and having a longitudinal axis slanted to the lens's faces; the component comprising a spherically shaped portion which interfaces with the bore to ensure full contact therebetween, when the component is attached to said lens.

50. A curved lens designed for having attached thereto a component, the lens having an edge, a first face, a second face and a bore passing between them and having a longitudinal axis slanted to the lens's faces; the component being attachable to the lens at said bore, the lens comprising one or more component engaging parts at its edge for inter-engaging with the component to thereby minimizing movement between the lens and the component.

51. A component designed for attaching to a curved lens having an edge, a component engaging portion at said edge, a first face, a second face and a bore passing between them having a longitudinal axis slanted to the lens's faces; the component being attachable to the lens at said bore and comprising a lens engaging part formed for inter-engaging with the lens to thereby minimize movement between the lens and the component.
